(19) United States
(12) Patent Application Publication
(10) Pub. No.: US 2024/0174839 A1
(43) Pub. Date: May 30, 2024

(54) STABILIZER MIXTURE

(71) Applicant: BASF SE, Ludwigshafen am Rhein (DE)

(72) Inventors: Tania WEYLAND, Kaisten (CH); Heinz HERBST, Kaisten (CH); Michèle GERSTER, Kaisten (CH)

(21) Appl. No.: 18/284,459

(22) PCT Filed: Mar. 31, 2022
(86) PCT No.: PCT/EP2022/058559

§ 371 Date: Sep. 27, 2023

(30) Foreign Application Priority Data
Apr. 1, 2021 (EP) 21166522.9

(51) Int. Cl. C08K 13/02; C08J 5/18

(52) U.S. Cl. CPC C08K 13/02; C08J 5/18; C08J 2333/08

(57) ABSTRACT

The present invention relates to a stabilizer mixture comprising at least one compound selected from compound of formula (A) and compound of formula (B), and at least one antioxidant compound, wherein the weight ratio of at least one compound of formula (A) and/or the compound of formula (B) to at least one antioxidant is in the range of 1:2 to 1:20. Further, the present invention relates to a composition comprising an organic material and a stabilizer mixture. Furthermore, the present invention relates to the use of the stabilizer mixture for stabilizing an organic material exposed to light.

### CROSS-REFERENCE TO RELATED APPLICATIONS

This application is a National Stage Entry of PCT/EP2022/058559, filed Mar. 31, 2022, which claims priority to European Application No. 21166522.9, filed Apr. 1, 2021, the disclosures of each of which are hereby incorporated by reference in their entirety.

### FIELD OF THE INVENTION

The presently claimed invention relates to a stabilizer mixture comprising at least one compound selected from compound of formula (A) and compound of formula (B), and at least one antioxidant compound, wherein the weight ratio of at least one compound of formula (A) and/or the compound of formula (B) to at least one antioxidant is in the range of 1:2 to 1:20. Further, the presently claimed invention relates to a composition comprising an organic material and a stabilizer mixture. The presently claimed invention also relates to the use of the stabilizer mixture for stabilizing an organic material exposed to light.

### BACKGROUND OF THE INVENTION

Organic materials namely synthetic polymers such as polyolefins, polyethylenes, and the like are used in wide variety of applications due to their ease of use in the manufacturing of a variety of extruded and moulded articles. However, these articles frequently suffer from general stability due to repeated exposure to the UV light. To prevent the detrimental effects of UV light on the articles prepared from the organic material, different additives or additive mixtures are used. However, some classes of additives (for e.g., antioxidants) are not light stable.

Thus, it is an object of the present invention to provide a stabilizer mixture to stabilize the non-light stable additives.

### SUMMARY OF THE INVENTION

Surprisingly, it has been found that the stabilizer mixture of the presently claimed invention stabilize the non-light stable additives in articles when exposed to light.

Thus, in one aspect, the presently claimed invention is directed to a stabilizer mixture comprising
(i) at least one compound selected from compound of formula (A) and compound of formula (B),

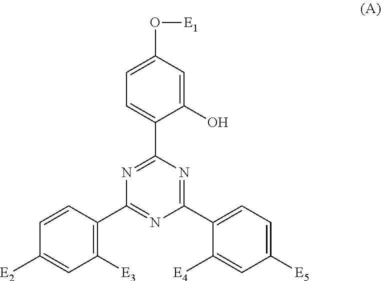

wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C₁-C₄alkyl; and

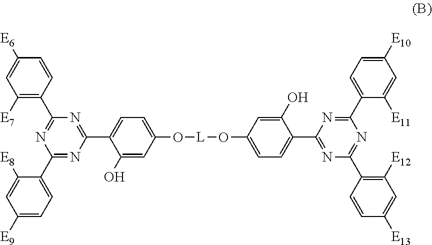

Wherein
L is ROCOR′COOR, wherein R and R′ independently of one another are C₁ to C₁₈ alkylidene
E6, E7, E8, E9, E10, E11, E12, E13 independently of one another are hydrogen, C₁-C₁₈ alkyl, phenyl or phenyl substituted by 1, 2 or 3 C₁-C₄ alkyl; and
(ii) at least one antioxidant compound,
   wherein the weight ratio of at least one compound of formula (A) and/or the compound of formula (B) to at least one antioxidant is in the range of 1:2 to 1:20.

In another aspect, the presently claimed invention is directed to a composition comprising an organic material and a stabilizer mixture as defined above.

In yet another aspect, the presently claimed invention is directed to the use of the stabilizer mixture as defined above for stabilizing an organic material exposed to light.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Further-more, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention de-scribed herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a stabilizer mixture comprising
i. at least one compound selected from compound of formula (A) and compound of formule (B),

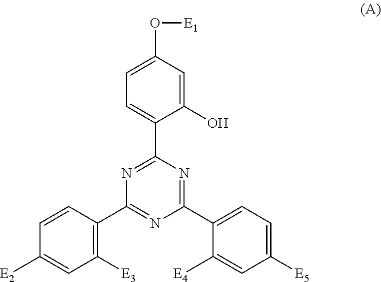

wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C₁-C₄alkyl; and

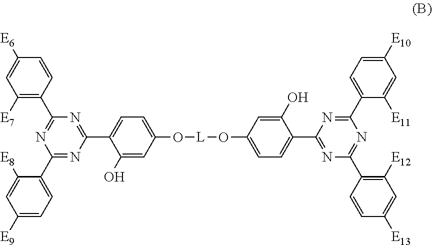

Wherein
L is ROCOR′COOR, wherein R and R′ independently of one another are C₁ to C₁₈ alkylidene
E6, E7, E8, E9, E10, E11, E12, E13 independently of one another are hydrogen, C₁-C₁₈ alkyl, phenyl or phenyl substituted by 1, 2 or 3 C₁-C₄ alkyl; and
ii. at least one antioxidant compound,
   wherein the weight ratio of at least one compound of formula (A) and/or the compound of formula (B) to at least one antioxidant is in the range of 1:2 to 1:20, preferably 1:2 to 1:15, and more preferably 1:2 to 1:10.

In an exemplary embodiment, the weight ratio of at least one compound of formula (A) to at least one antioxidant is 1:3.33.

In an embodiment, the presently claimed invention is directed to a stabilizer mixture comprising:
i. at least one compound selected from compound of formula (A),

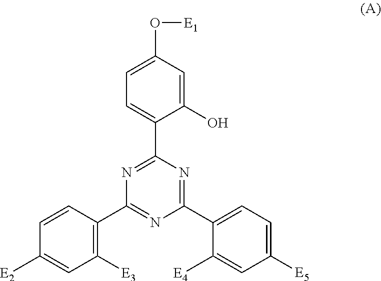

wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C₁-C₄alkyl; and
ii. at least one antioxidant,
   wherein the weight ratio of at least one compound of formula (A) to at least one antioxidant is in the range of 1:2 to 1:20, preferably 1:2 to 1:15, and more preferably 1:2 to 1:10.

### Compound of Formula (A):

In an embodiment, the stabilizer mixture comprises at least one compound of formula (A)

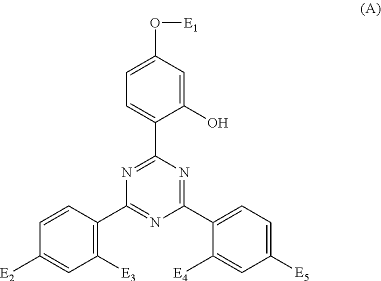

In an embodiment, E₁ is C₁-C₁₈ alkyl, preferably C₁-C₈ alkyl.

In an embodiment, E₂, E₃, E₄ and E₅ independently of one another are hydrogen, C₁-C₁₈ alkyl, phenyl or phenyl substituted by 1, 2 or 3 C₁-C₄alkyl, preferably E₂, E₃, E₄ and E₅ independently of one another are hydrogen, C₁-C₄ alkyl or phenyl.

Examples of alkyl having up to 18 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethyl-butyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

In a preferred embodiment, the at least one compound of formula (A) is selected from the formulae (A-1), (A-2) and (A-3).

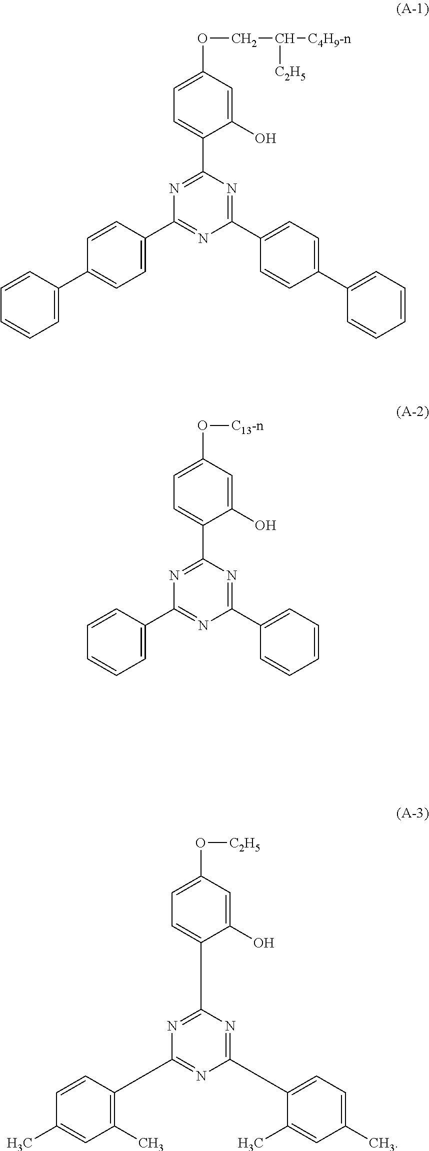

Most of the compounds of the formulae (A) are known and can be prepared in analogy to processes known to those skilled in the art.

The compounds of the formula (A) can be prepared for example in analogy to the methods described in U.S. Pat. No. 6,255,483.

### Compound of Formula (B):

In an embodiment, the stabilizer mixture comprises at least one compound of formula (B).

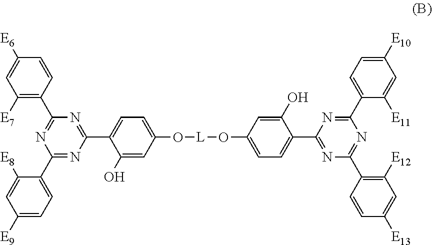

In an embodiment, L is ROCOR′COOR, wherein R and R′ independently of one another are C₁ to C₁₈ alkylidene.

In an embodiment, E₆, E₇, E₈, E₉, E₁₀, E₁₁, E₁₂, and E₁₃ independently of one another are hydrogen, C₁-C₁₈ alkyl, phenyl or phenyl substituted by 1, 2 or 3 C₁-C₄ alkyl, preferably E₆, E₇, E₈, E₉, E₁₀, E₁₁, E₁₂, and E₁₃ independently of one another are hydrogen, C₁-C₄ alkyl or phenyl.

Examples of alkylidene having up to 18 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, and octadecylidene.

Examples of alkyl having up to 4 carbon atoms are methyl, ethyl, propyl, isopropyl, n-butyl, sec-butyl, isobutyl, tert-butyl, and 2-ethylbutyl.

In a preferred embodiment, the at least one compound of formula (B) is selected from the formula (B-1).

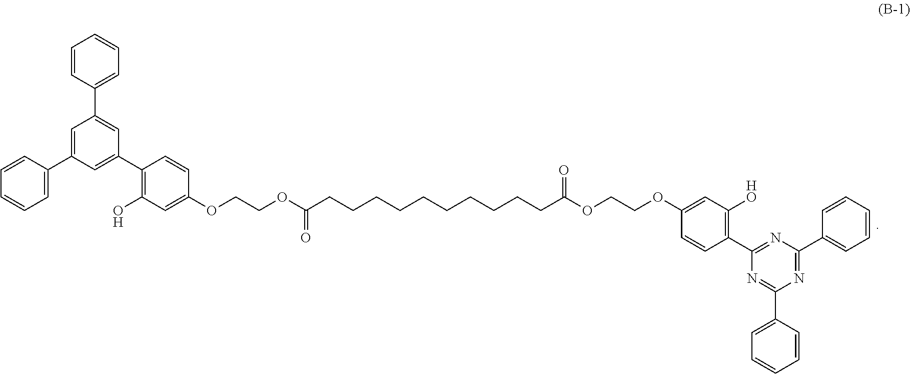 [SMILES: O=C(CCCCCCCCCCC(=O)OCCOc1ccc(-c2nc(-c3ccccc3)nc(-c3ccccc3)n2)c(O)c1)OCCOc1ccc(-c2cc(-c3ccccc3)cc(-c3ccccc3)c2)c(O)c1]

In an embodiment, the presently claimed invention is directed to a stabilizer mixture comprising
i. at least one compound selected from compound of formula (A) and compound of formula (B-1),

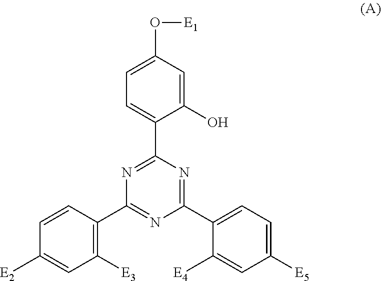

wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C₁-C₄alkyl; and

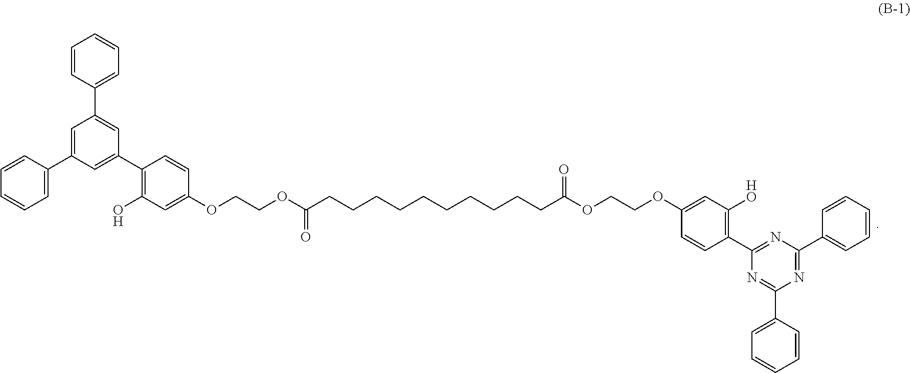 [SMILES: O=C(CCCCCCCCCCC(=O)OCCOc1ccc(-c2nc(-c3ccccc3)nc(-c3ccccc3)n2)c(O)c1)OCCOc1ccc(-c2cc(-c3ccccc3)cc(-c3ccccc3)c2)c(O)c1]

and
ii. at least one antioxidant compound,
   wherein the weight ratio of at least one compound of formula (A) and/or the compound of formula (B-1) to at least one antioxidant is in the range of 1:2 to 1:20, preferably 1:2 to 1:15, and more preferably 1:2 to 1:10.

The antioxidant is selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl) isocyanurate, pentaerythritol tetrakis[3-[3,5-di-tert-butyl-4-hydroxyphenyl]propionate, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, octadecyl 3-(3,5-di-tert-butyl-4-hydroxyphenyl)propionate, octyl-3,5-di-tert-butyl-4-hydroxy-hydrocinnamate, Hexamethylene bis[3-(3,5-di-tert-butyl-4-hydroxyphenyl) propionate], 3-(3,5-ditert-butyl-4-hydroxyphenyl)-N-[6-[3-(3,5-ditert-butyl-4-hydroxyphenyl) propanoylamino]hexyl]propenemide, calcium bis[monoethyl (3,5-di-tert-butyl-4-hydroxylbenzyl)phosphonate], triethylene glycol bis(3-tert-butyl-4-hydroxy-5-methylphenyl) propionate, 3,5-di-tert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl) propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-utylphenol, bis(1,2,2,6,6-pentamethyl-4-piperidyl) [[3,5-bis(1,1-dimethylethyl)-4-hydroxyphenyl]methyl]butylmalonate, α-to-copherol, 3-(3,5-ditert-butyl-4-hydroxyphenyl)-N′[3-(3,5-ditert-butyl-4-hydroxyphenyl)propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis(6-tert-butyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl) sulfanyl-5-methylphenyl]phosphite, (1,2-dioxoethylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), 4,6-bis (octylthiomethyl)-o-cresol, bis(octadecyl)hydroxylamine, benzenamine, N-phenyl-, reaction products with 2,4,4-trimethylpentene, 3,3′-thiodipropionic acid di-n-octadecyl ester, didodecyl 3,3′-thiodi-propionate, 4,4′-bis(α,α-dimethylbenzyl)diphenylamine, 3,3′-thiodipropionic acid dimyristyl ester, dioctadecyl disulfide, and 2,2-Bis[[3-(dodecylthio)-1-oxopropoxy]methyl]propane-1,3-diyl bis[3-(dodecylthio)propionate]. In a preferred embodiment, the antioxidant is selected from the group consisting of 2,4-bis (octylmercapto)-6-(3,5-di-tert-butyl-4-hydroxyanilino)-1,3,5-triazine, 2-octylmercapto-4,6-bis (3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl)isocyanurate, 2,4,6-tris(3,5-di-tert-butyl-4-hydroxy-phenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris(3,5-di-tert-butyl-4- hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, octadecyl 3-(3,5-di-tert-butyl-4-hydroxyphenyl)propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl)propanoylamino]hexyl] propeneamide, calcium bis[monoethyl(3,5-di-tert-butyl-4-hydroxylbenzyl)phosphonate], triethylene glycol bis(3-tert-butyl-4-hydroxy-5-methylphenyl)propionate, 3,5-di-tert-butyl-4-hydroxyhy-drocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl)propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-butylphenol, bis(1,2,2,6,6- pentamethyl-4-piperidyl) [[3,5-bis(1,1-dimethylethyl)-4-hydroxy-phenyl]methyl]butylmalonate, α-tocopherol, 3-(3,5-ditert-butyl-4-hydroxyphenyl)-N′-[3-(3,5-ditert-butyl-4-hydroxyphenyl) propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxy-phenyl]butanoate], benzyl-2-acetamido-2-deoxy-α-D-galactopyranoside, 2,2′-Methylenebis (6-tert-butyl-4-methylphenol) monoacrylate, 2-propenoic acid, 2-(1,1-dimethylethyl)-6-[1-[3-(1,1-dimethylethyl)-5-(1,1- dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl) sulfanyl-5-methylphenyl]phosphite, (1,2-dioxoe0thylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), and 4,6-bis (octylthiomethyl)-o-cresol.

In a more preferred embodiment, the antioxidant is selected from the group consisting of 1,3,5-tris(3,5-di-tert-butyl-4-hydroxybenzyl)isocyanurate, pentaerythritol tetrakis[3-[3,5-di-tert-butyl-4-hydroxyphenyl]propionate, and 1,3,5-tris(3,5-di-tert-butyl-4-hydroxybenzyl)-2,4,6-trimethylbenzene.

In an embodiment, the stabilizer mixture further comprises at least one thiosynergist. The at least one thiosynergist is selected from the group consisting of dilauryl thiodipropionate, dimistryl thiodipropionate, pentaerythritol tetrakis[3-(dodecylthio) propionate], distearyl thiodipropionate and distearyl disulphide, preferably distearyl thiodipropionate.

In another aspect, the presently claimed invention is directed to a composition comprising:
a. an organic material, and
b. a stabilizer mixture as defined above.

In an embodiment, the organic material is selected from:

1. Polymers of monoolefins and diolefins, for example polypropylene, polyisobutylene, poly-but-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
17. Polyureas, polyimides, polyamide-imides, polyetherimides, polyesterimides, polyhydantoins and polybenzimidazoles.
18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylenesuccinate/terephtalate, polybutyleneadipate/terephthalate, polytetramethyleneadipate/terephthalate, polybutylensuccinate/-adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.
19. Polycarbonates and polyester carbonates.

### 20. Polyketones.

21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
31. Aqueous emulsions of natural or synthetic rubber, e.g. natural latex or latices of carboxylated styrene/butadiene copolymers.

The organic material is preferably selected from polymers of monoolefins and diolefins, copolymers of monoolefins and diolefins with each other or with other vinyl monomers, hydrocarbon resins and mixtures of polyalkylenes and starch, polystyrene, poly(p-methylstyrene), poly(α-methylstyrene), graft copolymers of vinyl aromatic monomers such as styrene or α-methylstyrene, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, Polyphenylene oxides and sulfides, polyurethanes derived from hydroxyl-terminated polyethers, polyesters or polybutadienes on the one hand and aliphatic or aromatic polyisocyanates on the other, polyamides and copolyamides derived from diamines and dicarboxylic acids and/or from aminocarboxylic acids or the corresponding lactams, polyureas, polyimides, polyamideimides, polyetherimides, polyesterimides, polyhydantoins and polybenzimidazoles, polyesters derived from dicarboxylic acids and diols and/or from hydroxycarboxylic acids or the corresponding lactones or lactides, polycarbonates and polyester carbonates, polyketones, polysulfones, polyether sulfones and polyether ketones, crosslinked polymers derived from aldehydes on the one hand and phenols, ureas and melamines on the other hand, drying and non-drying alkyd resins, unsaturated polyester resins derived from copolyesters of saturated and unsaturated dicarboxylic acids with polyhydric alcohols and vinyl compounds as crosslinking agents, crosslinkable acrylic resins derived from substituted acrylates, alkyd resins, polyester resins and acrylate resins crosslinked with melamine resins, urea resins, isocyanates, isocyanurates, polyisocyanates or epoxy resins, crosslinked epoxy resins derived from aliphatic, cycloaliphatic, heterocyclic or aromatic glycidyl compounds, natural polymers such as cellulose, rubber, gelatin and chemically modified homologous derivatives thereof, aqueous emulsions of natural or synthetic rubber, linear low-density polyethylene, low-density polyethylene, high density polyethylene, ethylene-vinyl acetate copolymer, ethylene-butyl acrylate copolymer, polypropylene homopolymer and polypropylene copolymer.

The stabilizer mixture according to the present invention is present in the organic material to be stabilized in an amount of preferably 0.005 to 10% or 0.005 to 5%, in particular 0.01 to 2.5% or 0.05 to 2%, relative to the weight of the organic material.

The individual components of the present stabilizer mixture may be added to the organic material to be stabilized either individually or mixed with one another. They can be added to a polymer before, during or after the polymerization or before or after the crosslinking.

The stabilizer mixture according to the present invention or its individual components can be incorporated into the organic material to be stabilized by known methods, for example before or during shaping or by applying the dissolved or dispersed stabilizer to the organic material, if necessary with subsequent evaporation of the solvent. The stabilizers can be added to the organic material in the form of a powder, granules or a masterbatch.

### Examples of Processing or Transformation of the Materials Stabilized According to the Present Invention Are

Injection blow molding, extrusion, blow molding, rotomolding, in mold decoration (back injection), slush molding, injection molding, co-injection molding, forming, compression molding, pressing, film extrusion (cast film; blown film), fiber spinning (woven, non-woven), drawing (uniaxial, biaxial), annealing, deep drawing, calandering, mechanical transformation, sintering, coextrusion, coating, lamination, crosslinking (radiation, peroxide, silane), vapor deposition, weld together, glue, vulkanization, thermoforming, pipe extrusion, profile extrusion, sheet extrusion; sheet casting, spin coating, strapping, foaming, recycling/rework, extrusion coating, visbreaking (peroxide, thermal), fiber melt blown, spun bonded, surface treatment (corona discharge, flame, plasma), sterilization (by gamma rays, electron beams), cast polymerization (R&M process, RAM extrusion), gel-coating, tape extrusion, GMT-process, SMC-process, plastisol, and dipping (PVC, latex).

In an embodiment, the composition further comprises at least one sterically hindered amine light stabilizer.

The at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethyl-piperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl) pyrrolidine-2,5-dione, a mixture of 4-hexadecyloxy- and 4-stearyloxy-2,2,6,6-tetramethylpiperidine, a condensate of N,N′-bis (2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4- piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4- piperidyl)hexa-methylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4- piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2- hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexayl)oxymethyl-3,3,5-trimethyl-2-morpholinone, the reaction product of 2,4-bis[(1-cyclohexyloxy-2,2,6,6-piperidine-4-yl)butylamino]- 6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-entamethylpiperazine-3-one-4-yl)amino)-s-triazine, 4-N-butyl-2-N,4-N-bis(2,2,6,6-tetramethylpiperidin-4- yl)-2-N-[6-[(2,2,6,6-tetramethylpiperidin-4-yl)amino]hexyl]-1,3,5-triazine-2,4-diamine, N,N′-bis(2,2,6,6-tetramethyl-4-piperidyl)-N,N′- diformylhexamethylenediamine, and mixtures thereof.

In a preferred embodiment, the sterically hindered amine light stabilizer is a condensate of 1,6-hexanediamine and 2,4,6-trichloro-1,3,5-triazine as well as N,N-dibutylamine and 4-butylamino-2,2,6,6-tetra methylpiperidine.

In an embodiment, the composition further comprises at least one compound (C) selected from general formula (I), general formula (II), general formula (III), general formula (IV), and mixtures thereof.

### Compound (C) of General Formula (I):

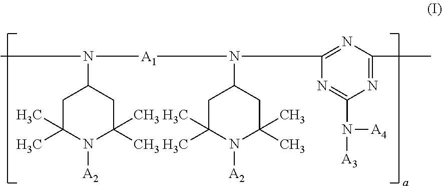 [0063] wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A2 is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂ cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

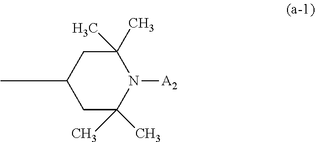

or
A₃ and A₄, together with the nitrogen atom to which they are bonded, form a 5- to 10-membered heterocyclic ring; and
a is an integer in the range of 1 to 20 and the repeating units are the same or different.

Within the context of the present invention, the term alkyl, as used herein, refers to acyclic saturated aliphatic residues, including linear or branched alkyl residues.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₁₂ alkyl include, but are not limited to, methyl, ethyl, n-propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, 2-propyl heptyl, n-octyl, 2-ethylhexyl, 1,1,3-trimethylhexyl, 1,1,3,3-tetramethylpentyl, n-nonyl, n-decyl, n-undecyl, isoundecyl, 1-methylundecyl, n-dodecyl, isododecyl, and 1,1,3,3,5,5-hexamethylhexyl.

Representative examples of C₁-C₁₂ alkyloxy include, but are not limited to, methoxy, ethoxy, propoxy, isopropoxy, butoxy, isobutoxy, pentoxy, isopentoxy, hexoxy, heptoxy, octoxy, nonyloxy, decyloxy, undecyloxy, and dodecyloxy.

In a preferred embodiment, alkyloxy is selected from methoxy, ethoxy, propoxy, isopropoxy, butoxy, isobutoxy, pentoxy, isopentoxy, hexoxy, heptoxy and octoxy. In a more preferred embodiment, alkyloxy is propoxy.

Representative examples of C₅-C₁₂ cycloalkyl are cyclopentyl, cyclohexyl, cycloheptyl, cyclooctyl, cyclononyl, cyclodecyl, cycloundecyl, and cyclododecyl.

Representative examples of C₅-C₁₂cycloalkyloxy are cyclopentoxy, cyclohexoxy, cycloheptoxy, cyclooctoxy, cyclononyloxy, cyclodecyloxy, cycloundecyloxy, and cyclododecyloxy.

In a preferred embodiment the cylcoalkyloxy is cyclohexoxy.

A preferred example of phenyl substituted by 1, 2 or 3 C₁-C₄alkyl is 2,4-dimethylphenyl.

Preferred C₂-C₁₈ alkylene are ethylene, propylene, trimethylene, tetramethylene, pentamethylene, 2,2-dimethyltrimethylene and hexamethylene. In a more preferred embodiment, alkylene is hexamethylene.

An example of C₅-C₇ cycloalkylene is cyclohexylene.

An example of C₁-C₄ alkylenedi(C₅-C₇ cycloalkylene) is methylenedicyclohexylene.

Examples of the radicals A₃ and A₄ together with the nitrogen atom to which they are bonded, forming a 5- to 10-membered heterocyclic ring, are 1-pyrrolidyl, piperidyl, morpholinyl, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl, preferably morpholinyl.

In the compound (A) of the general formula (I) the terminal group attached to the diamino residue is for example hydrogen or a group of the formula

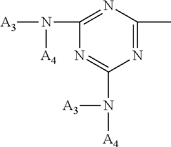

and the terminal group attached to the triazine radical is for example a group of the formula

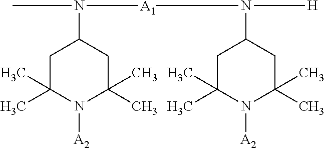

or a group of the formula

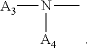

In a preferred embodiment, A₁ is hexamethylene, and A₂ is hydrogen, and propoxy.

In a preferred embodiment, A₃ is butyl,

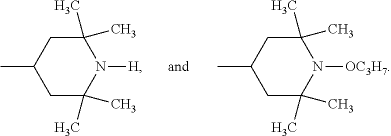

In a preferred embodiment, A₄ is butyl.

In a preferred embodiment, a is an integer in the range of 1 to 10.

### Compound (C) of General Formula (II)

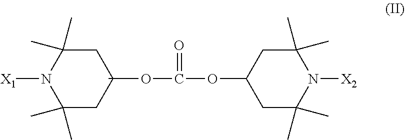 [0089] wherein
x₁ and x₂ is independently selected from C₁ to C₃₀ alkoxy,

In a preferred embodiment, x₁ and x₂ are independently selected from linear or branched, unsubstituted C₁ to C₃₀ alkyloxy.

Representative examples of linear or branched, unsubstituted C₁ to C₃₀ alkyloxy are methyloxy, ethyloxy, propyloxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, icosyloxy, henicosyloxy, docosyloxy, tricosyloxy, tetracosyloxy, pentacosyloxy, hexacosyloxy, heptacosyloxy, octacosyloxy, nonacosyloxy and triacontyloxy.

In a preferred embodiment, x₁ and x₂ are each undecyloxy.

### Compound (C) of General Formula (III)

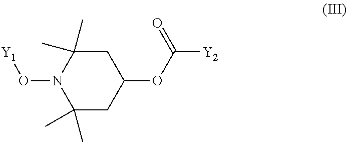 [0095] wherein
Y₁ is linear or branched, substituted or unsubstituted C₃ to C20 alkyl,
Y₂ is C₁ to C₃₀ alkyl; and

In a preferred embodiment, Y₁ is linear or branched, unsubstituted C₃ to C₂₀ alkyl.

In an embodiment, Y₁ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosyl.

In a preferred embodiment, Y₁ is selected from propyl, and dodecyl.

In a preferred embodiment, Y₂ is linear or branched, unsubstituted C₁ to C₃₀ alkyl.

In an embodiment, Y₂ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

In a preferred embodiment, Y₂ is selected from pentadecyl, and heptadecyl.

### Compound (C) of General Formula (IV)

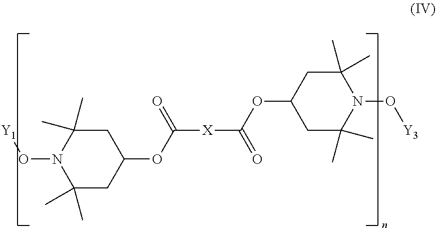 [0105] wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.

In a preferred embodiment, Y₃ is selected from linear or branched, unsubstituted C₃ to C₂₀ alkyl and C₃ to C₂₀ alkylidene.

Representative examples of alkylidene having up to 20 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, octadecylidene, nonadecylidene, and icosylidene.

In a preferred embodiment, Y₁ is selected from decyl.

In a preferred embodiment, Y₃ is selected from decyl, and nonylidene.

In a preferred embodiment, the compound (C) is selected from the formulae (C-I), (C-II), (C-III), (C-IV), (C-V), (C-VI), (C-VII), and (C-VIII).

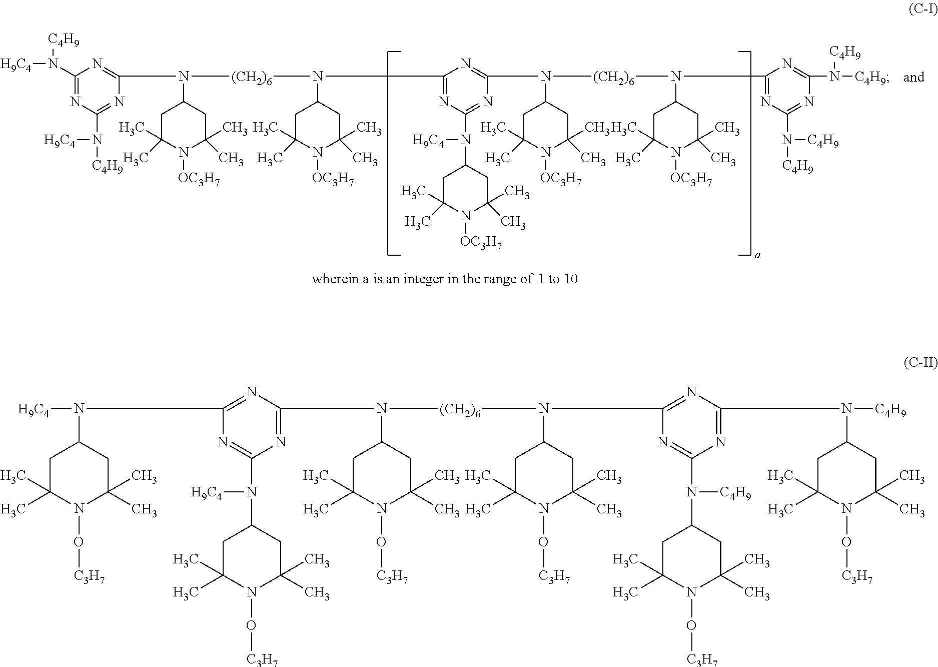

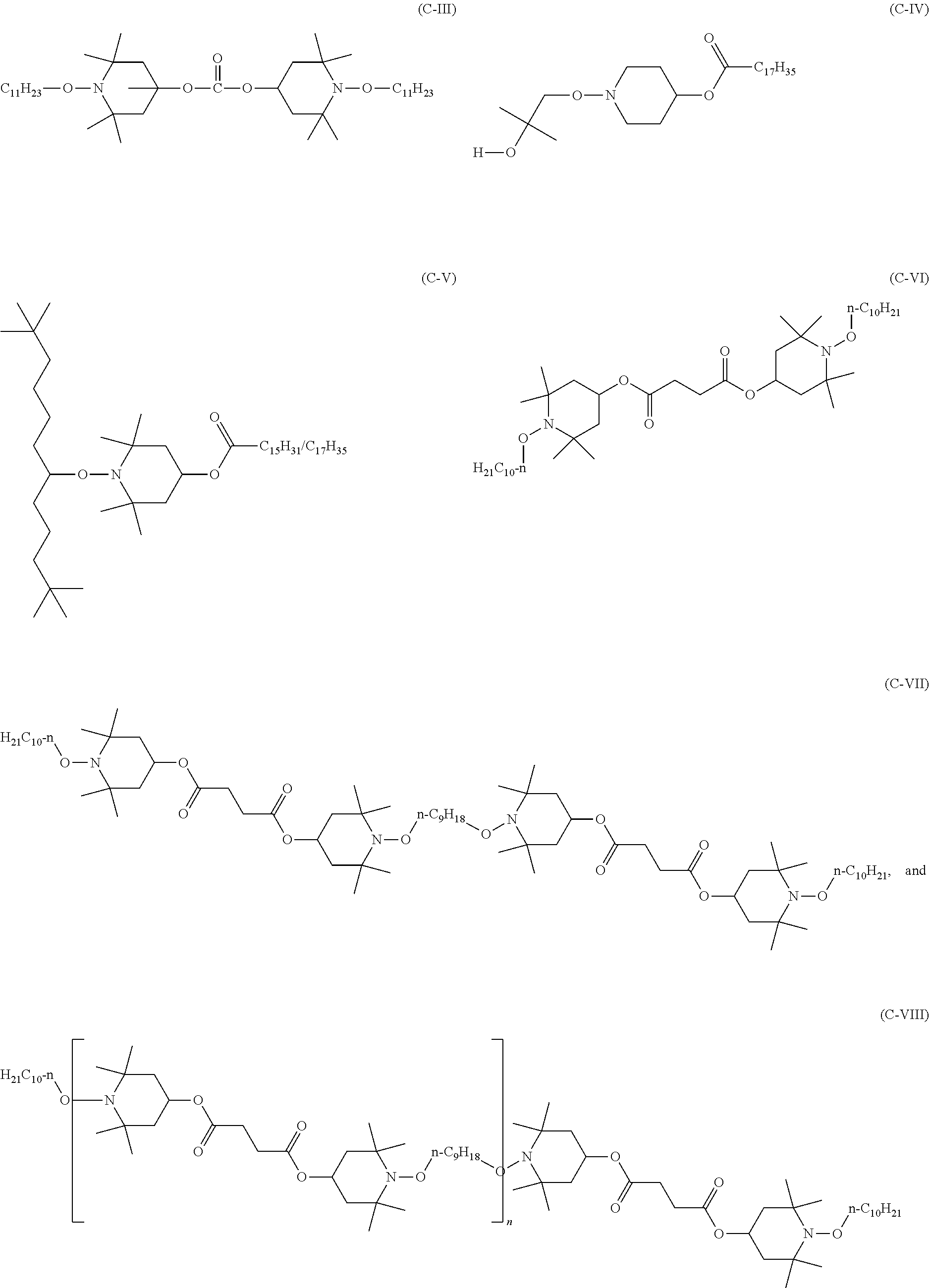

wherein n is 2.

In an embodiment, the composition further comprises at least one additive selected from the slip agents, anti-block agents, thermal fillers, pigments, anti-fog and anti-mist agents. In an embodiment, the composition further comprises metal hydroxide as fillers and/or acid scavengers.

The composition may additionally also contain various conventional additives, for example:
1. Antioxidants
1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(cc-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2- (3′-tert-butyl-2′-hydroxy-5′-methyl benzyl)-6-tert-butyl-4-methyl phenyl]terephthalate, 1,1-bis-(3,5-dimethyl-2-hydroxyphenyl)butane, 2,2-bis(3,5-di-tert-butyl-4-hydroxyphe-nyl)propane, 2,2-bis (5-tert-butyl-4-hydroxy2-methylphenyl)-4-n-dodecylmercaptobutane, 1,1,5,5-tetra-(5-tert-butyl-4-hydroxy-2-methyl phenyl) pentane.
1.7. O—, N— and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis (3,5-di-tert-butyl-4-hydroxybenzyl)malonate, bis[4-(1,1,3,3-tetramethylbutyl) phenyl]-2,2-bis(3,5-di-tert-butyl-4-hydroxybenzyl)malonate.
1.9. Aromatic hydroxybenzyl compounds, for example 1,4-bis(3,5-di-tert-butyl-4-hydroxybenzyl)-2,3,5,6-tetramethylbenzene, 2,4,6-tris(3,5-di-tert-butyl-4-hydroxybenzyl) phenol.
1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of 13-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl) oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylol propane, 4-hydroxymethyl-1-phospha-2,6,7-trioxabicyclo[2.2.2] octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl) oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenylpropionyl) hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.
2. UV absorbers and light stabilizers
2.1. 2-(2′-Hydroxyphenyl)benzotriazoles, for example 2-(2′-hydroxy-5′-methylphenyl)-benzo-triazole, 2-(3′,5′-di-tert-butyl-2′-hydroxyphenyl)benzotriazole, 2-(5′-tert-butyl-2′-hydroxyphenyl) benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro- benzotriazole, 2-(3′-tert-butyl-2′-hydroxy-5′-methylphenyl)-5-chloro-benzotriazole, 2-(3′-sec-butyl-5′-tert-butyl-2′- hydroxyphenyl)benzotriazole, 2-(2′-hydroxy-4′-40 octyloxyphenyl)benzotriazole, 2-(3′,5′-di-tert-amyl-2′-hydroxyphenyl)benzotriazole, 2-(3′,5′-bis- (oc,oc-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyl-oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyI]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

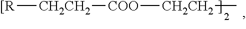

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetra methyl butyl)-5′-(α,α-dimethyl benzyl)-phenyl]benzotriazole.
2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butyl-phenyl salicylate, phenyl salicylate, octylphenyl salicylate, dibenzoyl resorcinol, bis(4-tert-butylben-zoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.
2.5. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.6. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.7.2-(2-Hydroxyphenyl)-1,3,5-triazines, for example 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4- dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3- butyloxypropoxy)phenyl]-4,6-bis (2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4- bis(4-[2-ethylhexyloxy]-2-hydroxyphenyl)-6-(4-methoxyphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl) pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl) phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl) phenyl triesters (CAS: 939402-02-5)., phosphorous acid, triphenyl ester, polymer with α-hydro-ω-hydroxypoly[oxy(methyl-1,2-ethanediyl)], C10-16-alkyl esters (CAS: 1227937-46-3).

The following phosphites are especially preferred:

Tris(2,4-di-tert-butylphenyl) phosphite (Irgafos®168, Ciba Specialty Chemicals Inc.), tris(nonylphenyl) phosphite,

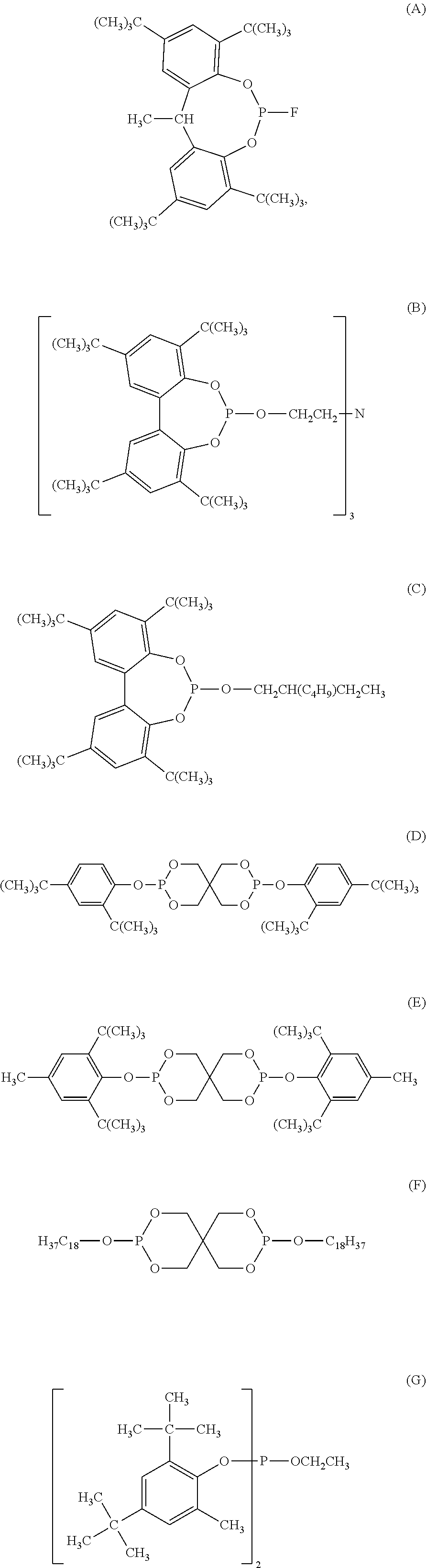

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydrox-ylamine, N-heptadecyl-N-octadecylhydroxylamine, N,N-dialkylhydroxylamine derived from hydrogenated tallow amine.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, pentaerythritol tetrakis[3-(dodecylthio) propionate], distearyl thiodipropionate or distearyl disulfide.
8. Peroxide scavengers, for example esters of p-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis((3-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene) sorbitol, and 1,3:2,4-di(benzylidene)sorbitol.
12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.

The preferred metal hydroxide is magnesium aluminum hydroxycarbonate.
13. Other additives, for example plasticisers, lubricants, emulsifiers, pigments, rheology additives, catalysts, flow-control agents, optical brighteners, flameproofing agents, antistatic agents and blowing agents. Additionally, acid scavengers can also be used.

The preferred acid scavenger is magnesium aluminum hydroxycarbonate.
14. Benzofuranones and indolinones, for example those disclosed in U.S. Pat. Nos. 4,325,863; 4,338,244; 5,175,312; 5,216,052; 5,252,643; DE-A-4316611;

DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2- one, 3-(3,4-dimethylphenyl)-5,7-di-tert-butyl benzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

The weight ratio of the present stabilizer mixture to the total amount of the conventional additive(s) can be for example 100:1 to 1:1000 or 10:1 to 1:100 or 20 to 1 to 1 to 20 or 10:1 to 1:10.

The materials stabilized according to this invention can be used in a wide variety of forms, for example as films, fibres, tapes, moulding compositions, profiles or as binders for paints, adhesives or putties.

In more detail, the materials stabilized according to the present invention may be used for the preparation of the following devices:
I-1) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.
I-2) Devices for plane, railway, motor car (car, motorbike) including furnishings.
I-3) Devices for space applications, in particular rockets and satellites, e.g. reentry shields.
I-4) Devices for architecture and design, mining applications, acoustic quietized systems, street refuges, and shelters.
II-1) Electric appliances, in particular washing machines, tumblers, ovens (microwave oven), dish-washers, mixers, and irons.
II-2) Foils for condensers, refrigerators, heating devices, air conditioners, encapsulating of electronics, semi-conductors, coffee machines, and vacuum cleaners.
III-1) Technical articles such as cogwheel (gear), slide fittings, spacers, screws, bolts, handles, and knobs.
III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.
III-3) Profiles of any geometry (window panes) and siding.
III-4) Glass substitutes, in particular extruded plates, glazing for buildings (monolithic, twin or multiwall), aircraft, schools, extruded sheets, window film for architectural glazing, train, transportation, sanitary articles, and greenhouse.
III-5) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.
III-6) Cement-, concrete-, composite-applications and covers, siding and cladding, hand rails, banisters, kitchen work tops, roofing, roofing sheets, tiles, and tarpaulins.
IV-1) Plates (walls and cutting board), trays, artificial grass, astroturf, artificial covering for stadium rings (athletics), artificial floor for stadium rings (athletics), and tapes.
V-1) Plastic films in general (packaging, dump, laminating, swimming pools covers, waste bags, wallpaper, stretch and shrink wrap, raffia, desalination film, batteries, and connectors).
V-2) Agricultural films (greenhouse covers, tunnel, mulch, silage, bale wrap), especially in presence of intensive application of agrochemicals).
VI-1) Food packing and wrapping (flexible and solid), BOPP, BOPET, bottles.
VI-2) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.
VII-1) Devices of filled polymers (talc, chalk, china clay (kaolin), wollastonite, pigments, carbon black, TiO₂, mica, nanocomposites, dolomite, silica, silicates, glass, asbestos).

Thus, another embodiment of the present invention is an article made of a composition as defined above.

In another aspect, the presently claimed invention is directed to the use of the at least one compound of formula (A) and/or the compound of formula (B) as defined above for preventing degradation of antioxidant compound as defined above. In another aspect, the presently claimed invention is directed to the use of the stabilizer mixture as defined above for stabilizing an organic material exposed to light.

The presently claimed invention offers one or more of following advantages:
1. The stabilizer mixture of the presently claimed invention stabilize the non-light stable additives in articles when exposed to light.
2. Due to the use of stabilizer mixture of the present invention, the non-light stable additives can be used in light exposed articles, which prolongs the durability of the end article.

In the following, specific embodiments of the presently claimed invention are described:

1. A stabilizer mixture comprising
i. at least one compound selected from compound of formula (A) and compound of formula (B),

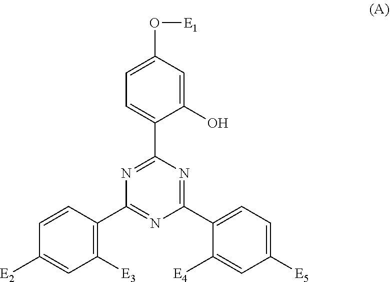

wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C₁-C₄alkyl; and

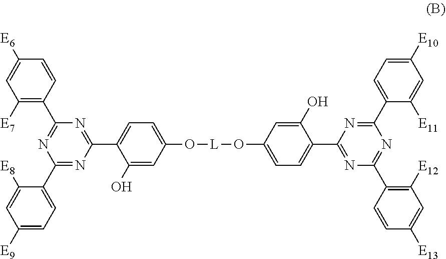

Wherein
L is ROCOR′COOR, wherein R and R′ independently of one another are C₁ to C₁₈ alkylidene
E6, E7, E8, E9, E10, E11, E12, E13 independently of one another are hydrogen, C₁-C₁₈ alkyl, phenyl or phenyl substituted by 1, 2 or 3 C₁-C₄ alkyl; and
ii. at least one antioxidant compound,
   wherein the weight ratio of at least one compound of formula (A) and/or the compound of formula (B) to at least one antioxidant is in the range of 1:2 to 1:20.
      2. The stabilizer mixture according to embodiment 1, wherein E₁ is C₁-C₈ alkyl and E₂, E₃, E₄ and E₅ independently of one another are hydrogen, C₁-C₄ alkyl or phenyl.
      3. The stabilizer mixture according to embodiments 1 or 2, wherein L is ROCOR′COOR, wherein R and R′ independently of one another are C₁ to C₁₈ alkylidene, and E₆, E₇, E₈, E₉, E₁₀, E₁₁, E₁₂, and E₁₃ independently of one another are hydrogen, C₁-C₄ alkyl or phenyl.
      4. The stabilizer mixture according to one or more of embodiments 1 to 3, wherein the at least one compound of formula (A) is selected from the formulae (A-1), (A-2) and (A-3).

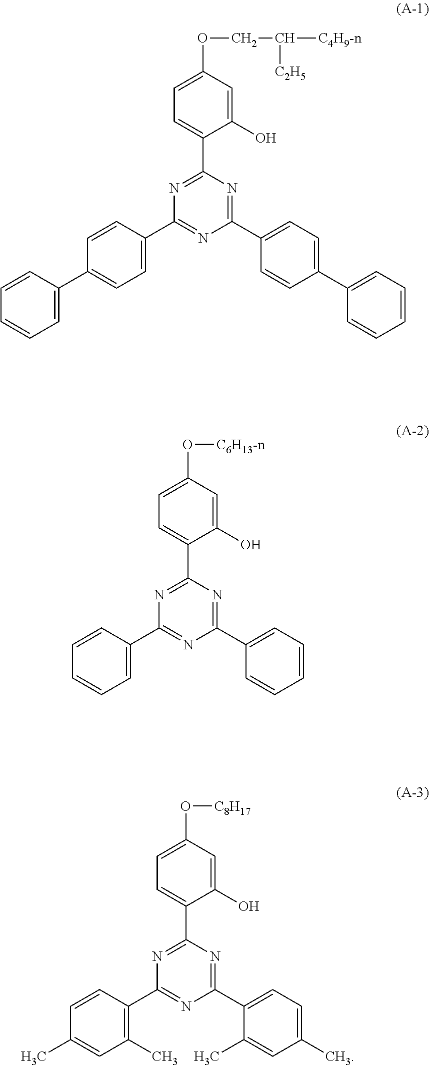

5. The stabilizer mixture according to one or more of embodiments 1 or 3, wherein the compound of formula (B) is a compound of formula (B-1)

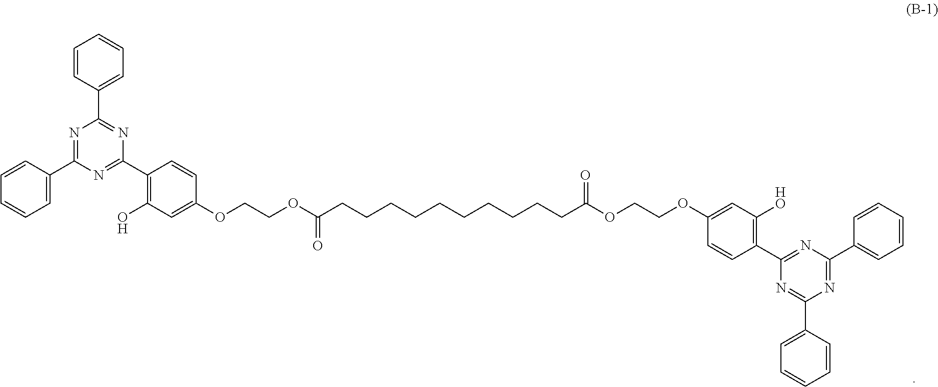 [SMILES: O=C(CCCCCCCCCCC(=O)OCCOc1ccc(-c2nc(-c3ccccc3)nc(-c3ccccc3)n2)c(O)c1)OCCOc1ccc(-c2nc(-c3ccccc3)nc(-c3ccccc3)n2)c(O)c1]

6. The stabilizer mixture according to embodiment 1, wherein the antioxidant is selected from the group consisting of 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzypisocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6- tetramethylbenzene, 2,4,6-tris(3,5-di-tert-butyl-4-hydroxybenzyl)phenol, octadecyl 3-(3,5-di-tert-butyl-4-hydroxyphenyl) propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl) propanoylamino]hexyl]propenamide, calcium bis[monoethyl(3,5-di-tert-butyl-4-hydroxylbenzyl)phosphonate], triethylene glycol bis(3-tert-butyl-4-hydroxy-5-methylphenyl)propionate, 3,5-di-tert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl) propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-butylphenol, bis(1,2,2,6,6-pentamethyl-4-piperidyl) [[3,5-bis(1,1-dimethylethyl)-4-hydroxyphenyl]methyl]butylmalonate, α-tocopherol, 3-(3,5-ditert-butyl-4-hydroxyphenyl)-N′-[3-(3,5-ditert-butyl-4-hydroxyphenyl)propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis(6-tert-butyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl) sulfanyl-5-methylphenyl]phosphite, (1,2-dioxoethylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), 4,6-bis (octylthiomethyl)-o-cresol, bis(octadecyl)hydroxylamine, benzenamine, N-phenyl-, reaction products with 2,4,4-trimethylpentene, 3,3′-thiodipropionic acid di-n-octadecyl ester, didodecyl 3,3′-thiodipropionate, 4,4′-bis(α,α-dimethylbenzyl)diphenylamine, 3,3′-thiodipropionic acid dimyristyl ester, dioctadecyl disulfide, and 2,2-Bis[[3-(dodecylthio)-1-oxopropoxy]methyl]propane-1,3-diyl bis[3-(dodecylthio)propionate].
7. The stabilizer mixture according to one or more of embodiments 1 and 6, wherein the antioxidant is selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetrame-thylbenzene, 2,4,6-tris(3,5-di-tert-butyl-4-hydroxybenzyl)phenol, octadecyl 3-(3,5-di-tert-butyl-4-hydroxyphenyl) propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl)propanoylamino]hexyl]propenamide, calcium bis[monoethyl(3,5-di-tert-butyl-4-hydroxylbenzyl)phosphonate], triethylene glycol bis(3-tert-butyl-4-hydroxy-5-methylphenyl)propionate, 3,5-di-tert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl)propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-butylphenol, bis(1,2,2,6,6-pentamethyl-4-piperidyl) [[3,5-bis(1,1-dimethylethyl)-4-hydroxyphenyl]methyl]butylmalonate, α-tocopherol, 3-(3,5-ditert-butyl-4-hydroxyphenyl)-N′-[3-(3,5-ditert-butyl-4-hydroxyphenyl)propanoyl]probe nehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis(6-tert-butyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl) sulfanyl-5-methylphenyl]phosphite, (1,2-dioxoe0thylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), and 4,6-bis (octylthiomethyl)-o-cresol.
8. The stabilizer mixture according to one or more of embodiments 1, 6, and 7, wherein the antioxidant is selected from the group consisting of 1,3,5-tris(3,5-di-tert-butyl-4-hydroxybenzyl)isocyanurate, pentaerythritol tetrakis[3-[3,5-di-tert-butyl-4-hydroxyphenyl]propionate, and 1,3,5-tris(3,5-di-tert-butyl-4-hydroxybenzyl)-2,4,6-trimethyl benzene.
9. The stabilizer mixture according to one or more of embodiments 1 to 8, further comprises at least one thiosynergist, wherein the at least one thiosynergist is selected from the group consisting of dilauryl thiodipropionate, dimistryl thiodipropionate, pentaerythritol tetrakis[3-(dodecylthio) propionate], distearyl thiodipropionate and distearyl disulphide.
10. The stabilizer mixture according to one or more of embodiments 1 to 9, wherein the thiosynergist is distearyl thiodipropionate.
11. A composition comprising:
c. an organic material, and
d. a stabilizer mixture according to one or more of embodiments 1 to 10.
   12. The composition according to embodiment 11, further comprises at least one sterically hindered amine light stabilizer.
   13. The composition according to one or more of embodiments 11 and 12, wherein the at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetra methyl piperidine, 4-stea ryloxy-2,2,6,6-tetramethylpiperidine, bis(1,2,2,6,6-pentamethylpiperidyl)-2-n-butyl-2-(2-hydroxy-3,5-di-tert-butyl benzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl) hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris (N-cyclohexyl-N-(1,2,2,6,6-pentamethylpiperazine-3-one-4-yl)amino)-s-triazine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, N,N′-bis(2,2,6,6-tetramethyl-4-piperidyl)-N,N′-diformylhexamethylenediamine, and mixtures thereof.
   14. The composition according to one or more of embodiments 11 to 13, further comprises at least one compound (C) selected from general formula (I), general formula (II), general formula (III), general formula (IV), and mixtures thereof

### Compound (C) of General Formula (I)

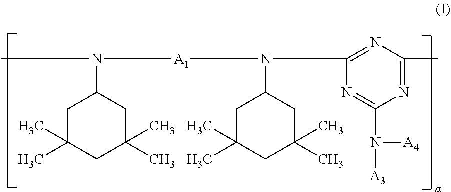 [0196] wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂ cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

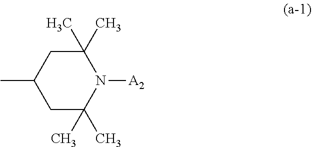

or
A₃ and A₄, together with the nitrogen atom to which they are bonded, form a 5- to 10-membered heterocyclic ring; and
a is an integer in the range of 1 to 20 and the repeating units are the same or different;

### Compound (C) of General Formula (II)

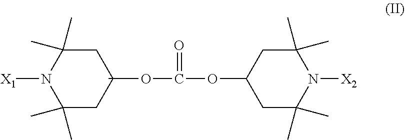 [0204] wherein
x₁ and x₂ is independently selected from C₁ to C₃₀ alkoxy,

### Compound (C) of General Formula (III)

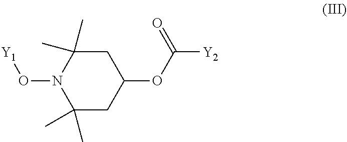 [0207] wherein
Y₁ is linear or branched, substituted or unsubstituted C₃ to C₂₃ alkyl,
Y2 is C₁ to C₃₀ alkyl; and

### Compound (C) of General Formula (IV)

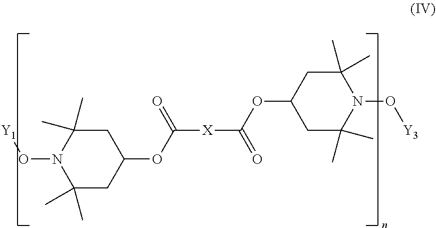 [0211] wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8
   15. The composition according to one or more of embodiments 11 to 14, wherein the compound (C) is selected from the formulae (C-I), (C-II), (C-III), (C-V), (C-VI), (C-VII), and (C-VIII).

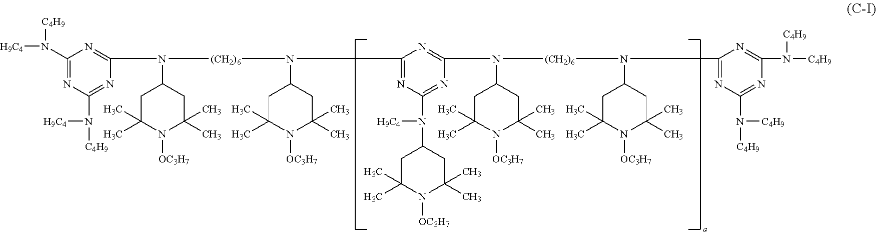

wherein a is an integer in the range of 1 to 10; and

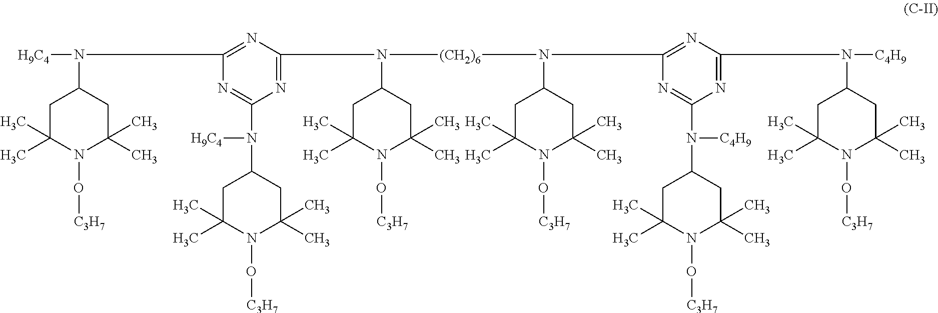

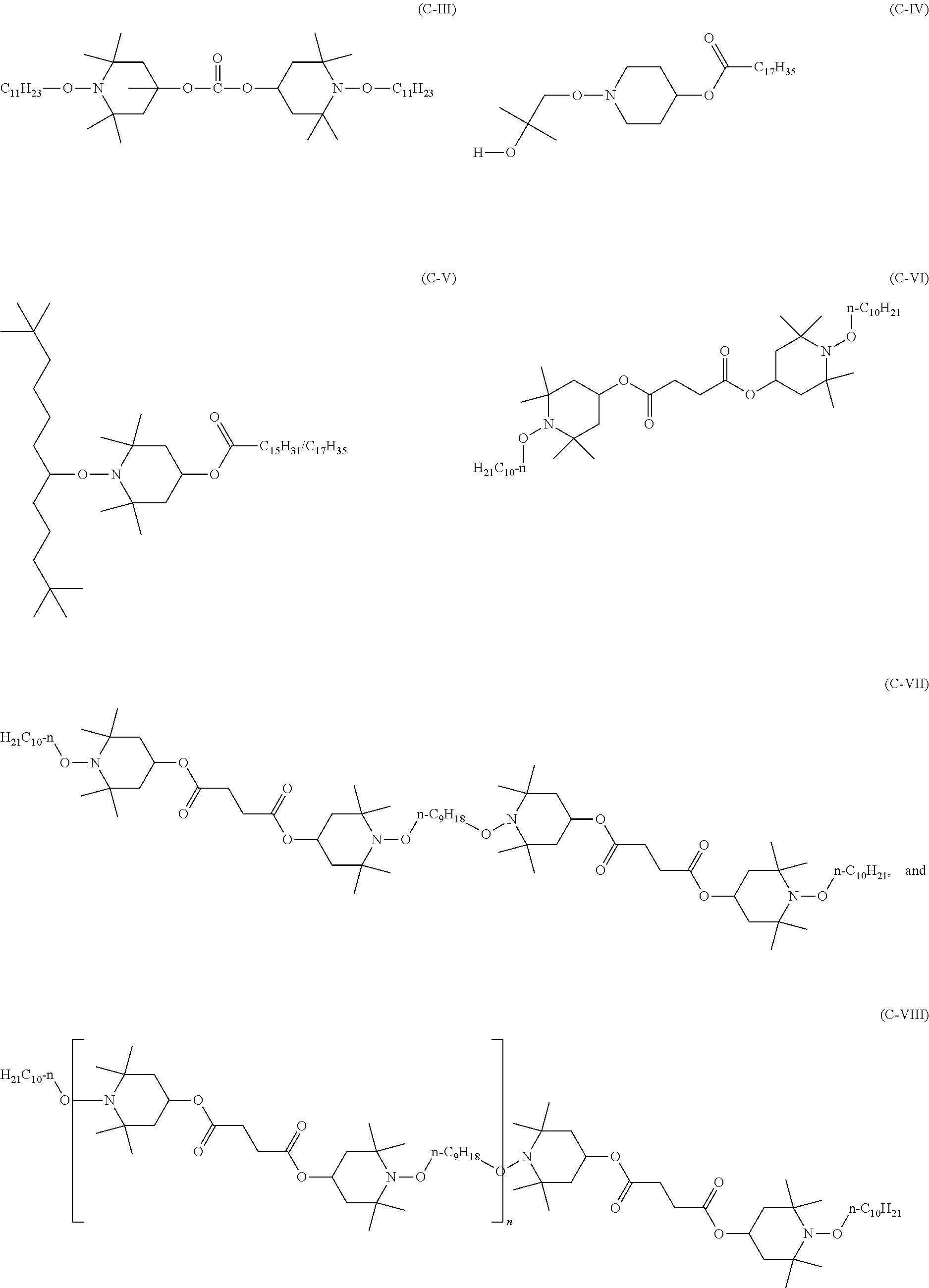

wherein n is 2.
   16. The composition according to one or more of embodiments 11 to 15, further comprises at least one additive selected from the UV stabilizers, slip agents, anti-block agents, thermal fillers, pigments, anti-fog and anti-mist agents.
   17. The composition according to one or more of embodiments 11 to 16, further comprises acid scavengers.
   18. The composition according to embodiment 16, wherein the UV stabilizer is selected from 2-(2′-hydroxyphenyl) benzotriazoles, 2-hydroxybenzophenones, 2-(2-hydroxyphenyl)-1,3,5-triazines, cyanoacrylates, oxanilide, benzoxazine and mixtures thereof.
   19. The composition according to embodiment 11, wherein the organic material is selected from polymers of monoolefins and diolefins, copolymers of monoolefins and diolefins with each other or with other vinyl monomers, hydrocarbon resins and mixtures of polyalkylenes and starch, polystyrene, poly(p-methylstyrene), poly(α-methylstyrene), graft copolymers of vinyl aromatic monomers such as styrene or α-methylstyrene, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, Polyphenylene oxides and sulfides, polyurethanes derived from hydroxyl-terminated polyethers, polyesters or polybutadienes on the one hand and aliphatic or aromatic polyisocyanates on the other, polyamides and copolyamides derived from diamines and dicarboxylic acids and/or from aminocarboxylic acids or the corresponding lactams, polyureas, polyimides, polyamide-imides, polyetherimides, polyesterimides, polyhydantoins and polybenzimidazoles, polyesters derived from dicarboxylic acids and diols and/or from hydroxycarboxylic acids or the corresponding lactones or lactides, polycarbonates and polyester carbonates, polyketones, polysulfones, polyether sulfones and polyether ketones, crosslinked polymers derived from aldehydes on the one hand and phenols, ureas and melamines on the other hand, drying and non-drying alkyd resins, unsaturated polyester resins derived from copolyesters of saturated and unsaturated dicarboxylic acids with polyhydric alcohols and vinyl compounds as crosslinking agents, crosslinkable acrylic resins derived from substituted acrylates, alkyd resins, polyester resins and acrylate resins crosslinked with melamine resins, urea resins, isocyanates, isocyanurates, polyisocyanates or epoxy resins, crosslinked epoxy resins derived from aliphatic, cycloaliphatic, heterocyclic or aromatic glycidyl compounds, natural polymers such as cellulose, rubber, gelatin and chemically modified homologous derivatives thereof, aqueous emulsions of natural or synthetic rubber, linear low-density polyethylene, low-density polyethylene, high density polyethylene, ethylene-vinyl acetate copolymer, ethylene-butyl acrylate copolymer, polypropylene homopolymer and polypropylene copolymer.
   20. The composition according to one or more of embodiments 11 to 19, wherein the stabilizer mixture is present in the organic material to be stabilized in an amount of 0.005 to 10% relative to the weight of the organic material.
   21. An article comprising the composition according to one or more of embodiments 11 to 20.
   22. Use of the at least one compound of formula (A) and/or the compound of formula (B) according to embodiment 1 for preventing degradation of antioxidant compound according to embodiment 1.
   23. Use of the stabilizer mixture according to one or more of embodiments 1 to 10 for stabilizing an organic material exposed to light.

The following examples illustrate the invention in greater detail. All percentages and parts are by weight, unless stated otherwise.

### EXAMPLES

Stabilizers listed in Tables 1, 2, 3, 4, and 5 below:

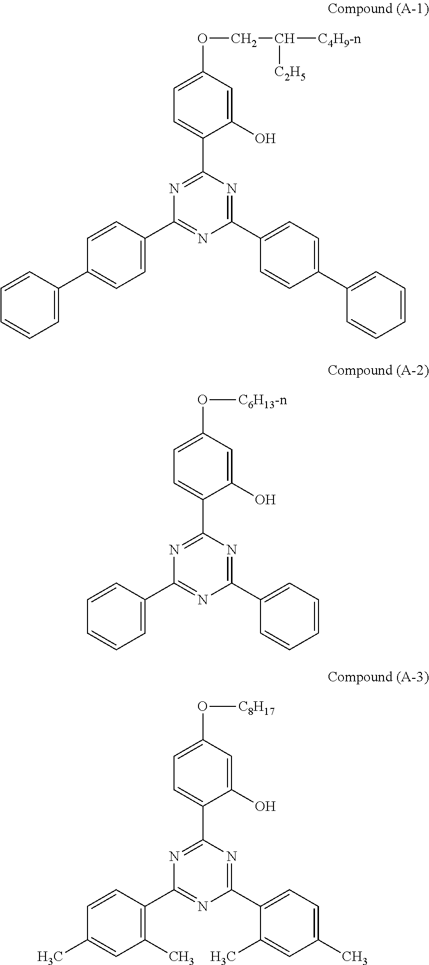

Compound D: A condensate of 1,6-hexanediamine and 2,4,6-trichloro-1,3,5-triazine as well as N,N-dibutylamine and 4-butylamino-2,2,6,6-tetramethylpiperidine

Antioxidant-1: Pentaerythritol tetrakis[3-[3,5-di-tert-butyl-4-hydroxyphenyl]propionate

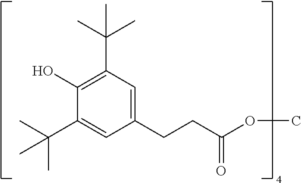

Antioxidant-2: 1,3,5-tris(3,5-di-tert-butyl-4-hydroxybenzyl)isocyanurate

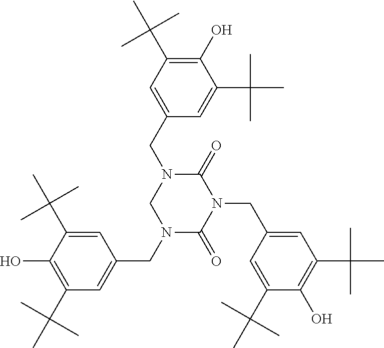 [SMILES: CC(C)(C)c1cc(CN2CN(Cc3cc(C(C)(C)C)c(O)c(C(C)(C)C)c3)C(=O)N(Cc3cc(C(C)(C)C)c(O)c(C(C)(C)C)c3)C2=O)cc(C(C)(C)C)c1O]

Antioxidant-3: 1,3,5-tris(3,5-di-tert-butyl-4-hydroxybenzyl)-2,4,6-trimethylbenzene

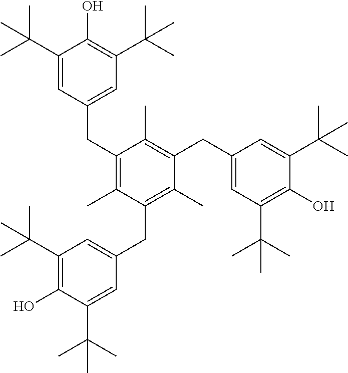 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1]

Antioxidant-4: Distearyl thiodipropionate

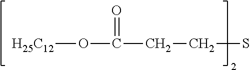

Compound E: Tris(2,4-di-tert-butylphenyl) phosphite

Compound F: Magnesium aluminum hydroxycarbonate

### (A) Preparation of the Film Samples

10 g of Plexiglas 7N are dissolved in 40 g Methylene Chloride together with 0.203 g of compound of tabes 1 to 5 (composed of 0.103 g of Antioxidant or 0.100 g Antioxidant plus 0.003 g Hydroxyphenyl-triazine). All compounds also contain 0.1 g of HALS (a condensate of 1,6-hex-anediamine and 2,4,6-trichloro-1,3,5-triazine as well as N,N-dibutylamine and 4-butylamino-2,2,6,6-tetramethylpiperidine) as Base stabilization for the integrity of the prepared film.

Films are drawn with the help of an automatic Blade (Erichsen) with a blade speed of 12 mm/sec and a gap of height of 120 mm. The prepared film is exposed to DIN ISO 4892-2 Cyclus 1 (Xenon light with Boro S/Boro S filters, 60 W/m2@300-400 nm (equivalent to 0.51 W/(m2-nm) @340 nm), BPT 65±2° C., 50+/−5% Rel. Humidity, Dry Bulk Temperature 38+/−3° C., 102 min, light, 18 min, water spray) using an Atlas 5000 devise or to DIN EN ISO 4892-2 Cyclus 5 (Xenon light with Boro S/Soda Lime filters, 50 W/m2@300-400 nm (equivalent to 0.43 W/(m2-nm) @340 nm), BPT 65±3° C., 50+/−10% Rel, Humidity, Dry Bulk Temperature 38+/−3° C., continuous light no water spray) using an Atlas CI 65 devise or to ASTM G 155 Cyclus 1 The % Absorption of the main UV is measured (250-500 nm) on a regular base using a Lambda 20 UV—vis spectrum from Perkin Elmer. The optical absorbance spectra are observed at the maximum absorbance of the AO were the maximum Absorbance are measured around 270-290 nm. The results of the Decrease in percentage of Absorption (% Abs) of the antioxidants are shown in Table 1 for the sample exposed to DIN ISO 4892-2 Cyclus 5 (Dry) and in Table 2 for the samples exposed to DIN EN ISO 4892-2 Cyclus 1 (Wet) and in the Table 3 for samples exposed to ASTM G 155 Cyclus 1 (dry) Xenon light with Boro S/Boro S filters, at 0.35 W/(m2-nm) @340 nm, BPT 63° C., 50+/−10% Rel. Humidity, Dry Bulk Temperature 42+/−4° C., using an Atlas devise.

The table shows the efficiency and inherent stability over time of the main antioxidant alone versus the same antioxidant plus hydroxypenyl triazine compound

Table 1 to 3: Decrease of UV Absorption of the antioxidants
in % in the film exposed to ISO 4892-2 cyclus 1 (Wet)

| | 1000 |
|---|---|
| Formulation | hours |
| 0.13% Antioxidant-1 | 76 |
| 0.03% Compound (A-1) + 0.1% Antioxidant-1 | 100 |
| 0.03% Compound (A-3) + 0.1% Antioxidant-1 | 82 |

PMMA solution film with 1% Compound D
UV spectrum Antioxidant-1 measured at 275 nm

TABLE 2

| | 350 |
|---|---|
| Formulation | hours |
| 0.13% Antioxidant-2 | 83 |
| 0.03% Compound (A-1) + 0.1% Antioxidant-2 | 100 |
| 0.03% Compound (A-2) + 0.1% Antioxidant-2 | 93 |

PMMA solution film with 1% Compound D
UV spectrum Antioxidant-2 measured at 280 nm

TABLE 3

| | 350 |
|---|---|
| Formulation | hours |
| 0.13% Antioxidant-3 | 89 |
| 0.03% Compound (A-2) + 0.1% Antioxidant-3 | 100 |

PMMA solution film with 1% Compound D
UV spectrum Antioxidant-3 measured at 275 nm

From tables 1 to 3, it is evident that the use of the hydroxyphenyl triazine compound along with antioxidant increases stability of the antioxidant in the film when exposed to light as compared to antioxidant alone.

TABLE 4
Decrease of UV Absorption of the antioxidants in %
in the film exposed to ASTM G 155 Cyclus 1 (dry)

| | 1100 |
|---|---|
| Formulation | hours |
| 0.13% Antioxidant-1 | 87 |
| 0.03% Compound (A-1) + 0.1% Antioxidant-1 | 100 |
| 0.03% Compound (A-3) + 0.1% Antioxidant-1 | 92 |

PMMA solution film with 1% Compound D
UV spectrum Antioxidant-1 measured at 275 nm

TABLE 5
Decrease of UV Absorption of the antioxidants in %
in the film exposed to ASTM G 155 Cyclus 1 (dry)

| | 300 |
|---|---|
| Formulation | hours |
| 0.13% Antioxidant-4 | 83 |
| 0.03% Compound (A-2) + 0.1% Antioxidant-4 | 100 |
| 0.03% Compound (A-2) + 0.5% Antioxidant-1 + | 89 |
| 0.5% Antioxidant-4 | |

PMMA solution film with 1% Compound D
UV spectrum Antioxidant-4 measured at 270 nm

From tabes 4 and 5, it is evident that the use of the hydroxyphenyl triazine compound along with antioxidant increases stability of the antioxidant in the film when exposed to light as compared to antioxidant alone.

### (B) Preparation of the Test Specimens

A mixture of a non-stabilised high-density polyethylene (HDPE; Hostalen® CRP-100; natural classified under PE 100 of LyondellBasell; Melt Flow Rate: 190° C./5.0 Kg: 0.23 g/10 min (ISO 1133); Density: 0.95 g/cm3 (ISO 1183)) and the additives listed in Table 6 were mixed with a Mixaco Lab CM12 high speed mixer device.

The obtained full formulation was then compounded on a Collin 25X42D extruder at 240° C. and then injection molded on an Engel HL65 injection molding machine at 230° C.

The injection molded plaques 40 mm×60 mm×2 mm were exposed to QUV-SE from QLab using the ASTM G 154-C1 (UV-A fluorescent lamp with no filter, 0.77 W/(m2-nm)@340 nm and BPT A:60±3 C &B: 50±3 C).

The parameters measured are Time & Heat Flow at maximum oxidation peak using a DSC Q2000 von TA Instrument (Waters) at 200° C. under O₂ after the 1600 hours QUV-SE (ASTM G 154-C1). The results are listed in Table 7.

The parameters measured were HP-OIT (@150° C. and 500 psi) using a DSC Q2000 von TA Instrument (Waters) TA with a pressure cell after the 1600 hours QUV-SE (ASTM G 154-C1). The results are listed in Table 8.

TABLE 6

| Additive Formulation | No. |
|---|---|
| 0.3% Antioxidant-1 + 0.1% Compound E | 1 |
| 0.3% Antioxidant-3 + 0.1% Compound E + | 2 |
| 0.1% Compound (A-2) | |
| 0.3% Antioxidant-3 + 0.1% Compound E + | 3 |
| 0.1% Compound F | |
| 0.3% Antioxidant-3 + 0.1% Compound E + | 4 |
| 0.1% Compound F + 0.1% Compound (A-2) | |
| 0.3% Antioxidant-3 + 0.1% Compound E + | 5 |
| 0.1% Compound F + 0.05% Compound (A-1) | |

TABLE 7
Time & Heat Flow at maximum Oxidation Peak

| | Time at maximum | Heat Flow at maxi- |
|---|---|---|
| Formulation | Oxidation Peak | mum Oxidation |
| No. | (min.) | Peak(W/g) |
| 1: Control 1 | 27 | 0.7 |
| 2 | 44 | 1.4 |
| 3: Control 2 | 17 | 0.6 |
| 4 | 58 | 1.3 |
| 5 | 40 | 1.1 |

The Table 7 shows that the inventive Formulations give longer Time & higher Heat Flow at maximum oxidation peak, showing superior stability of the specimens when exposed to QUV compared to formulations free of the Compound (A).

TABLE 8
HP-OIT in minutes @ 150° C and 500 psi

| Formulation | HP-OIT |
|---|---|
| No. | (min.) |
| 3: Control 2 | 70 |
| 4 | 140 |
| 5 | 426 |

The Table 8 shows that the inventive Formulations give longer HP-OIT (@150° C. and 500 psi), showing superior stability of the specimens when exposed to QUV compared to formulations free of the Compound (A).

1. A stabilizer mixture comprising
i. at least one compound selected from compound of formula (A) and compound of formula (B), 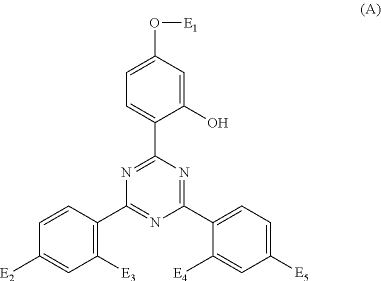
wherein
E₁ is C₁-C₁₈ alkyl; and
E₂, E₃, E₄ and E₅ independently of one another are hydrogen, C₁-C₁₈ alkyl, phenyl or phenyl substituted by 1, 2 or 3 C1-C4 alkyl; and 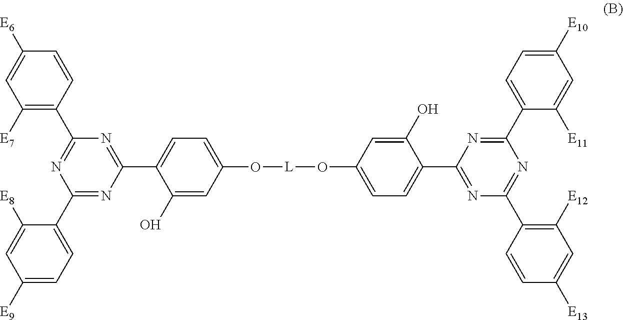
wherein
L is ROCOR′COOR, wherein R and R′ independently of one another are C₁ to C₁₈ alkylidene
E6, E7, E8, E9, E10, E11, E12, and E13 independently of one another are hydrogen, C₁-C₁₈ alkyl, phenyl or phenyl substituted by 1, 2 or 3 C₁-C₄ alkyl; and
ii. at least one antioxidant compound,
wherein the weight ratio of at least one compound of formula (A) and/or the compound of formula (B) to at least one antioxidant is in the range of 1:2 to 1:20.

2. The stabilizer mixture according to claim 1, wherein E₁ is C₁-C₈ alkyl and E₂, E₃, E₄ and E₅ independently of one another are hydrogen, C₁-C₄ alkyl or phenyl.

3. The stabilizer mixture according to claim 1, wherein L is ROCOR′COOR, wherein R and R′ independently of one another are C₁ to C₁₈ alkylidene, and E6, E7, E8, E9, E10, E11, E12, and E13 independently of one another are hydrogen, C₁-C₄ alkyl or phenyl.

4. The stabilizer mixture according to claim 1, wherein the at least one compound of formula (A) is selected from formulae (A-1), (A-2) or (A-3).

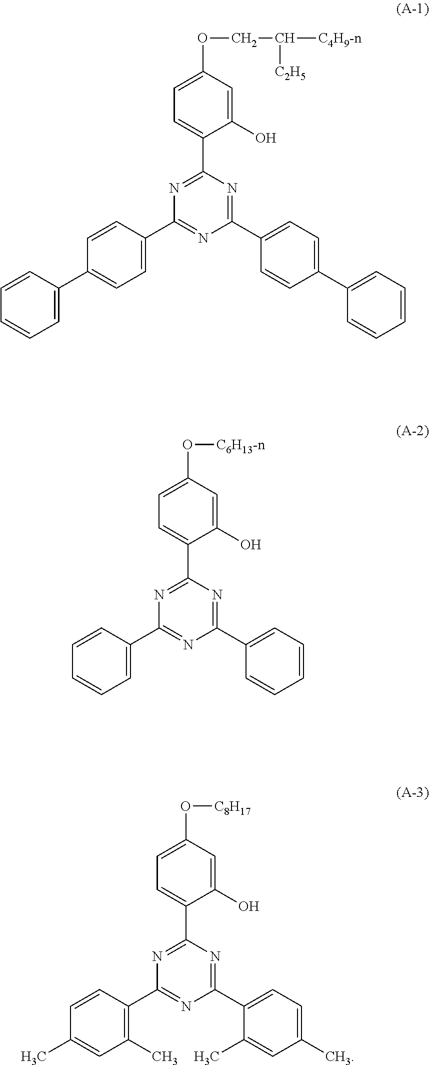

5. The stabilizer mixture according to claim 1, wherein the compound of formula (B) is a compound of formula (B-1)

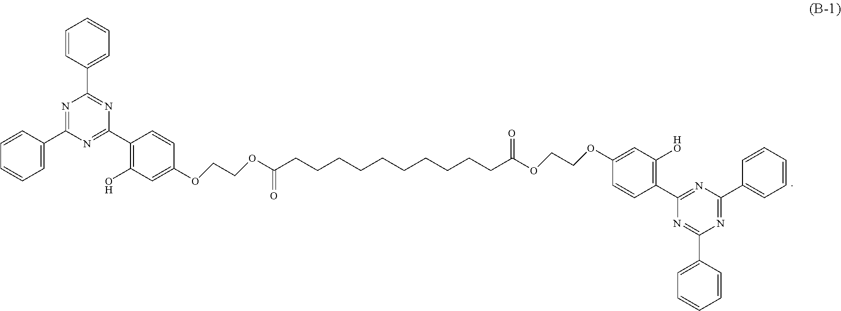 [SMILES: O=C(CCCCCCCCCCC(=O)OCCOc1ccc(-c2nc(-c3ccccc3)nc(-c3ccccc3)n2)c(O)c1)OCCOc1ccc(-c2nc(-c3ccccc3)nc(-c3ccccc3)n2)c(O)c1]

6. The stabilizer mixture according to claim 1, wherein the antioxidant is selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris (3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris (3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, octadecyl 3-(3,5-di-tert-butyl-4-hydroxyphenyl)propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl)propanoylamino]hexyl]propenamide, calcium bis[monoethyl(3,5-di-tert-butyl-4-hydroxylbenzyl)phosphonate], triethylene glycol bis (3-tert-butyl-4-hydroxy-5-methylphenyl)propionate, 3,5-di-tert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis (n-octylsulfanylmethyl)phenol, 2,2′-thiodiethylene bis[3-(3,5-di-tert-butyl-4-hydroxyphenyl)propionate], 2,4-di-tert-butylphenyl 3,5-di-tert-butyl-4-hydroxybenzoate, 4-((4,6-bis(octylthio)-1,3,5-triazin-2-yl) amino)-2,6-di-tert-butylphenol, bis(1,2,2,6,6-pentamethyl-4-piperidyl) [[3,5-bis(1,1-dimethylethyl)-4-hydroxyphenyl]methyl]butylmalonate, α-tocopherol, 3-(3,5-ditert-butyl-4-hydroxyphenyl)-N′-[3-(3,5-ditert-butyl-4-hydroxyphenyl)propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis (6-tert-butyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl)sulfanyl-5-methylphenyl]phosphite, (1,2-dioxoethylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), 4,6-bis (octylthiomethyl)-o-cresol, bis(octadecyl)hydroxylamine, benzenamine, N-phenyl-, reaction products with 2,4,4-trimethylpentene, 3,3′-thiodipropionic acid di-n-octadecyl ester, didodecyl 3,3′-thiodipropionate, 4,4′-bis(α,α-dimethylbenzyl)diphenylamine, 3,3′-thiodipropionic acid dimyristyl ester, dioctadecyl disulfide, and 2,2-Bis[[3-(dodecylthio)-1-oxopropoxy]methyl] propane-1,3-diyl bis[3-(dodecylthio)propionate].

7. The stabilizer mixture according to claim 1, wherein the antioxidant is selected from the group consisting of 2,4-bis(octylmercapto)-6-(3,5-di-tert-butyl-4-hydroxyanilino)-1,3,5-triazine, 2-octylmercapto-4,6-bis (3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris (3,5-di-tert-butyl-4-hydroxyphenoxy)-1,2,3-triazine, 1,3,5-tris (3,5-di-tert-butyl-4-hydroxybenzyl)isocyanurate, 1,3,5-tris (4-tert-butyl-3-hydroxy-2,6-dimethylbenzyl)isocyanurate, 2,4,6-tris (3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris (3,5-dicyclohexyl-4-hydroxybenzyl)isocyanurate, pentaerythritol tetrakis[3-[3,5-di-tert-butyl-4-hydroxyphenyl]propionate, 1,3,5-tris (3,5-di-tert-butyl-4-hydroxybenzyl)-2,4,6-trimethylbenzene, 1,4-bis (3,5-di-tert-butyl-4-hydroxybenzyl)-2,3,5,6-tetramethylbenzene, 2,4,6-tris (3,5-di-tert-butyl-4-hydroxybenzyl)phenol, octadecyl 3-(3,5-di-tert-butyl-4-hydroxyphenyl) propionate, octyl-3,5-di-tert-butyl-4-hydroxy-hydrocinnamate, Hexamethylene bis[3-(3,5-di-tert-butyl-4-hydroxyphenyl) propionate], 3-(3,5-ditert-butyl-4-hydroxyphenyl)-N-[6-[3-(3,5-ditert-butyl-4-hydroxyphenyl) propanoylamino]hexyl]propenamide, calcium bis[monoethyl(3,5-di-tert-butyl-4-hydroxylbenzyl) phosphonate], triethylene glycol bis(3-tert-butyl-4-hydroxy-5-methylphenyl)propionate, 3,5-di-tert-butyl-4-hydroxyhydrocinnamic acid 1,3,5-tris (2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl) propionate], 2,4-di-tert-butylphenyl 3,5-di-tert-butyl-4-hydroxybenzoate, 4-((4,6-bis(octylthio)-1,3,5-triazin-2-yl) amino)-2,6-di-tert-butylphenol, bis(1,2,2,6,6-pentamethyl-4-piperidyl) [[3,5-bis(1,1-dimethylethyl) -4-hydroxyphenyl]methyl]butylmalonate, α-tocopherol, 3-(3,5-ditert-butyl-4-hydroxyphenyl)-N′-[3-(3,5-ditert-butyl-4-hydroxyphenyl)propanoyl]propanehydrazide, tris (4-tert-butyl-3-hydroxy-2,6- dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis (6-tert-butyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenylester, tris[2-tert-butyl-4-(5-tert-butyl-4-hydroxy-2-methylphenyl)sulfanyl-5-methylphenyl]phosphite, (1,2-dioxoe0thylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), and 4,6-bis(octylthiomethyl)-o-cresol.

8. The stabilizer mixture according to claim 1, wherein the antioxidant is selected from the group consisting of 1,3,5-tris(3,5-di-tert-butyl-4-hydroxybenzyl)isocyanurate, pentaerythritol tetrakis[3-[3,5-di- tert-butyl-4-hydroxyphenyl]propionate, and 1,3,5-tris(3,5-di-tert-butyl-4-hydroxybenzyl)-2,4,6-trimethylbenzene.

9. The stabilizer mixture according to claim 1, further comprising at least one thiosynergist, wherein the at least one thiosynergist is selected from the group consisting of dilauryl thiodipropionate, dimistryl thiodipropionate, pentaerythritol tetrakis[3-(dodecylthio) propionate], distearyl thiodipropionate and distearyl disulphide.

10. The stabilizer mixture according to claim 1, wherein the thiosynergist is distearyl thiodipropionate.

11. A composition comprising:
a. an organic material, and
b. a stabilizer mixture according to claim 1.

12. The composition according to claim 11, further comprising at least one sterically hindered amine light stabilizer.

13. The composition according to claim 11, wherein the at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis (4-n-butylamino-2,2,6,6-tetramethylpiperidyl)-1,3,5-triazine and 1,2-bis (3-aminopropylamino) ethane, the condensate of 2-chloro-4,6-di-(4-n-butylamino-1,2,2,6,6-pentamethylpiperidyl)-1,3,5-triazine and 1,2-bis (3-aminopropylamino) ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl) pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis (2,2,6,6-tetramethyl-4-piperidyl)hexamethylenediamine and 4-cyclohexylamino-2,6-dichloro-1,3,5-triazine, a condensate of 1,2-bis (3-aminopropylamino) ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis (1,2,2,6,6-pentamethyl-4-piperidyloxycarbonyl)-2-(4-methoxyphenyl) ethene, N,N′-bis-formyl-N,N′-bis (2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-a-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpip eridine-4-yl)-N-butylamino]-6-(2-hydroxyethyl) amino-1,3,5-triazine, 1-(2-hydroxy-2-methylpropoxy)-4-octadecanoyloxy-2,2,6,6-tetramethylpip eridine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl) butylamino]-6-chloro-s-triazine with N,N′-bis(3-aminopropyl)ethylenediamine), 1,3,5-tris (N-cyclohexyl-N-(2,2,6,6-tetramethylpiperazine-3-one-4-yl)amino)-s-triazine, 1,3,5-tris (N-cyclohexyl-N-(1,2,2,6,6-pentamethylpiperazine-3-one-4-yl)amino)-s-triazine, 4-N-butyl-2-N,4-N-bis (2,2,6,6-tetramethylpiperidin-4-yl)-2-N-[6-[(2,2,6,6-tetramethylpiperidin-4-yl)amino]hexyl]-1,3,5-triazine-2,4-diamine, N,N′-bis(2,2,6,6-tetramethyl-4-piperidyl)-N,N′-diformylhexamethylenediamine, and mixtures thereof.

14. The composition according to claim 11, further comprising at least one compound (C) selected from general formula (I), general formula (II), general formula (III), general formula (IV), and mixtures thereof
compound (C) of general formula (I) 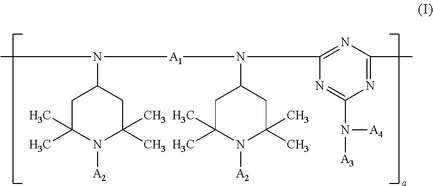
wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 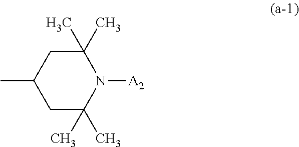
or
A₃ and A₄, together with the nitrogen atom to which they are bonded, form a 5- to 10-membered heterocyclic ring; and
a is an integer in the range of 1 to 20 and the repeating units are the same or different;
compound (C) of general formula (II) 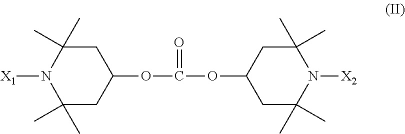
wherein
x₁ and x₂ is independently selected from C₁ to C₃₀ alkoxy,
compound (C) of general formula (III) 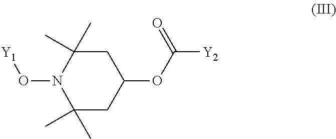
wherein
Y₁ is linear or branched, substituted or unsubstituted C₃ to C₂₀ alkyl,
Y₂ is C₁ to C₃₀ alkyl; and
compound (C) of general formula (IV) 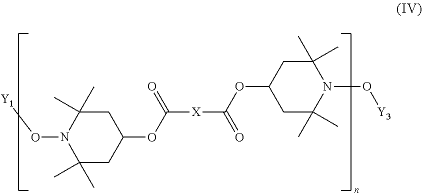
wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.

15. The composition according to claim 11, wherein the compound (C) is selected from the formulae (C-I), (C-II), (C-III), (C-IV), (C-V), (C-VI), (C-VII), and or (C-VIII): 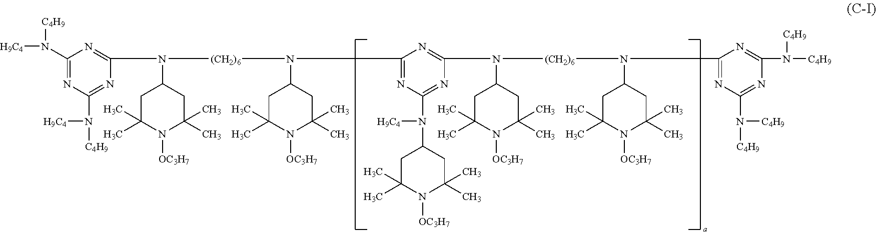
wherein a is an integer in the range of 1 to 10; and 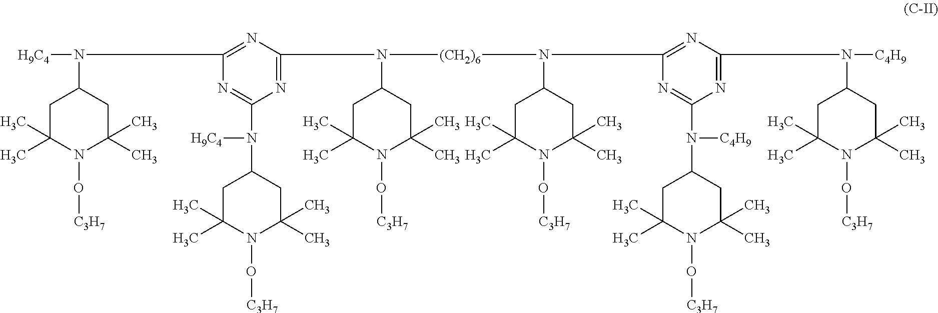 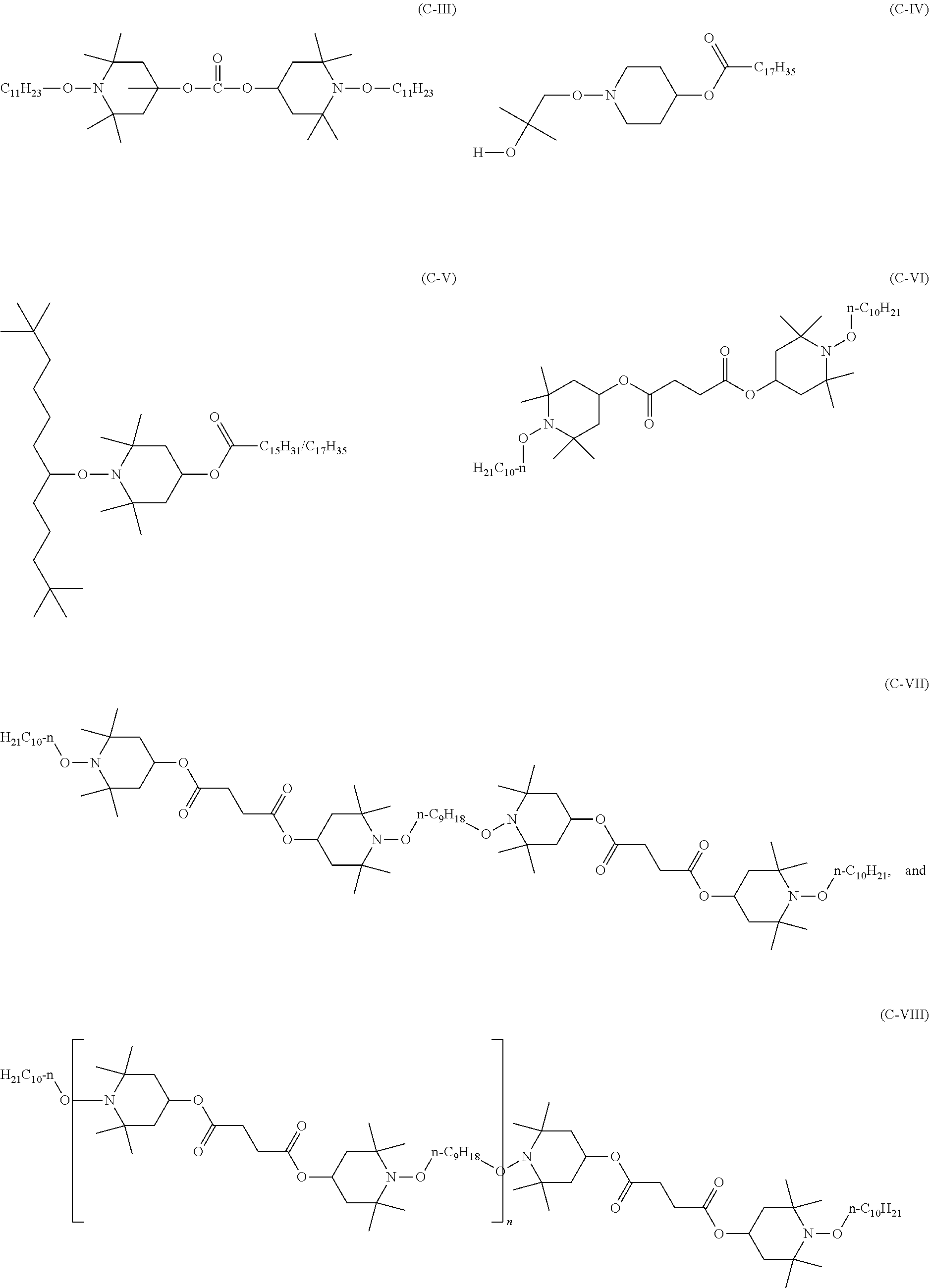
wherein n is 2.

16. The composition according to claim 11, further comprising at least one additive selected from the UV stabilizers, slip agents, anti-block agents, thermal fillers, pigments, anti-fog and anti-mist agents.

17. The composition according to claim 11, further comprising acid scavengers.

18. The composition according to claim 16, wherein the UV stabilizer is selected from 2-(2′-hydroxyphenyl) benzotriazoles, 2-hydroxybenzophenones, 2-(2-hydroxyphenyl)-1,3,5-triazines, cyanoacrylates, oxanilide, benzoxazine and mixtures thereof.

19. The composition according to claim 11, wherein the organic material is selected from polymers of monoolefins and diolefins, copolymers of monoolefins and diolefins with each other or with other vinyl monomers, hydrocarbon resins and mixtures of polyalkylenes and starch, polystyrene, poly(p-methylstyrene), poly(α-methylstyrene), graft copolymers of vinyl aromatic monomers such as styrene or α-methylstyrene, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, Polyphenylene oxides and sulfides, polyurethanes derived from hydroxyl-terminated polyethers, polyesters or polybutadienes on the one hand and aliphatic or aromatic polyisocyanates on the other, polyamides and copolyamides derived from diamines and dicarboxylic acids and/or from aminocarboxylic acids or the corresponding lactams, polyureas, polyimides, polyamide-imides, polyetherimides, polyesterimides, polyhydantoins and polybenzimidazoles, polyesters derived from dicarboxylic acids and diols and/or from hydroxycarboxylic acids or the corresponding lactones or lactides, polycarbonates and polyester carbonates, polyketones, polysulfones, polyether sulfones and polyether ketones, crosslinked polymers derived from aldehydes on the one hand and phenols, ureas and melamines on the other hand, drying and non-drying alkyd resins, unsaturated polyester resins derived from copolyesters of saturated and unsaturated dicarboxylic acids with polyhydric alcohols and vinyl compounds as crosslinking agents, crosslinkable acrylic resins derived from substituted acrylates, alkyd resins, polyester resins and acrylate resins crosslinked with melamine resins, urea resins, isocyanates, isocyanurates, polyisocyanates or epoxy resins, crosslinked epoxy resins derived from aliphatic, cycloaliphatic, heterocyclic or aromatic glycidyl compounds, natural polymers such as cellulose, rubber, gelatin and chemically modified homologous derivatives thereof, aqueous emulsions of natural or synthetic rubber, linear low-density polyethylene, low-density polyethylene, high density polyethylene, ethylene-vinyl acetate copolymer, ethylene-butyl acrylate copolymer, polypropylene homopolymer and polypropylene copolymer.

20. The composition according to claim 11, wherein the stabilizer mixture is present in the organic material to be stabilized in an amount of 0.005 to 10% relative to the weight of the organic material.

21. An article comprising the composition according to claim 11.

22. A method for preventing degradation of the antioxidant compound according to claim 1 comprising using at least one compound of formula (A) and/or the compound of formula (B) according to claim 1.

23. A method for stabilizing an organic material exposed to light comprising adding the stabilizer mixture according to claim 1 to the organic material.
